(19) United States
(12) Patent Application Publication
(10) Pub. No.: US 2017/0166396 A1
(43) Pub. Date: Jun. 15, 2017

(54) Trash Bin Liner

(71) Applicant: Tristin Hughes, Brookeland, TX (US)

(72) Inventor: Tristin Hughes, Brookeland, TX (US)

(21) Appl. No.: 15/376,182

(22) Filed: Dec. 12, 2016

Related U.S. Application Data
(60) Provisional application No. 62/265,532, filed on Dec. 10, 2015.

(51) Int. Cl. B65F 1/06; B65F 1/12; B65F 1/00

(52) U.S. Cl. CPC B65F 1/06; B65F 1/0026; B65F 1/12; B65F 2210/1023

(57) ABSTRACT

A trash bin liner configured to contain any unsanitary material leaked or spilled as a result of a torn or defective trash bag. The trash bin liner includes a body having an elastic band disposed on an upper end for enabling the body to be secured to the open end of a trash bin. A sidewall including a tapered section that extends radially outwardly relative to an interior volume of the body facilitates the securement of the upper end of the body to the open end of the trash bin. A pair of handles disposed on the upper end and a support handle disposed on the lower end facilitate the removal of the trash bin liner from a trash bin and the upending of the trash bin liner for dumping trash therefrom.

### CROSS REFERENCE TO RELATED APPLICATIONS

This application claims the benefit of U.S. Provisional Application No. 62/265,532 filed on Dec. 10, 2015. The above identified patent application is herein incorporated by reference in its entirety to provide continuity of disclosure.

### BACKGROUND OF THE INVENTION

The present invention relates to liners. More specifically, the present invention relates to a washable liner sized specifically to be inserted into a trash bin, fasten thereto, and receive a trash bag therein so as to prevent the contamination of the trash bin and the spread of odors therefrom.

Most individuals utilize a trash bin and trash bag inserted therein to dispose of and contain waste. However, trash bags often develop small unnoticeable tears or are improperly made, thereby leaking unsanitary material therethrough and contaminating the trash bin. Since a lot of individuals do not realize that the trash bag has torn or leaked material, the contaminated trash bin will go unnoticed for quite some time. As a result, the unsanitary material develops foul odors that permeate the environment surrounding the trash bin, creating a foul smell throughout a home or structure. Therefore, there is a need for a trash bin liner sized specifically for a trash bin and composed of an absorbent material configured to receive and contain any unsanitary material leaked or spilled through a trash bag.

### SUMMARY OF THE INVENTION

In view of the foregoing disadvantages inherent in the known types of liners now present in the prior art, the present invention provides a trash bin liner wherein the same can be utilized for providing convenience for the user when disposing of and containing waste. The present system comprises a trash bin liner including a body sized to form fit to a trash bin. The body includes an upper end, a closed lower end, and an upstanding sidewall extending from the upper end to the closed lower end. The upstanding sidewall defines an interior volume configured to receive a trash bag and includes a tapered section and a vertical section. The tapered section begins at the upper end and terminates at the vertical section. The vertical section begins at a lower end of the tapered section and terminates at the closed lower end. The tapered section extends radially outwardly relative to the interior volume of the body and tapers radially inwardly from the upper end towards the closed lower end. The tapered section includes a diameter larger than the diameter of the vertical section. An elastic band is disposed annularly around the upper end and is biased radially inwardly relative to the interior volume.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the trash bin liner.

FIG. 2 shows a perspective view of the trash bin liner as mounted into a trash bin.

FIG. 3 shows a perspective bottom view of the trash bin liner.

FIG. 4 shows a cross-sectional view of the trash bin liner.

FIG. 5 shows an exploded view of the trash bin liner being inserted into a trash bin and receiving a trash bag.

### DETAILED DESCRIPTION OF THE INVENTION

Reference is made herein to the attached drawings. Like reference numerals are used throughout the drawings to depict like or similar elements of the trash bin liner. The figures are intended for representative purposes only and should not be considered to be limiting in any respect.

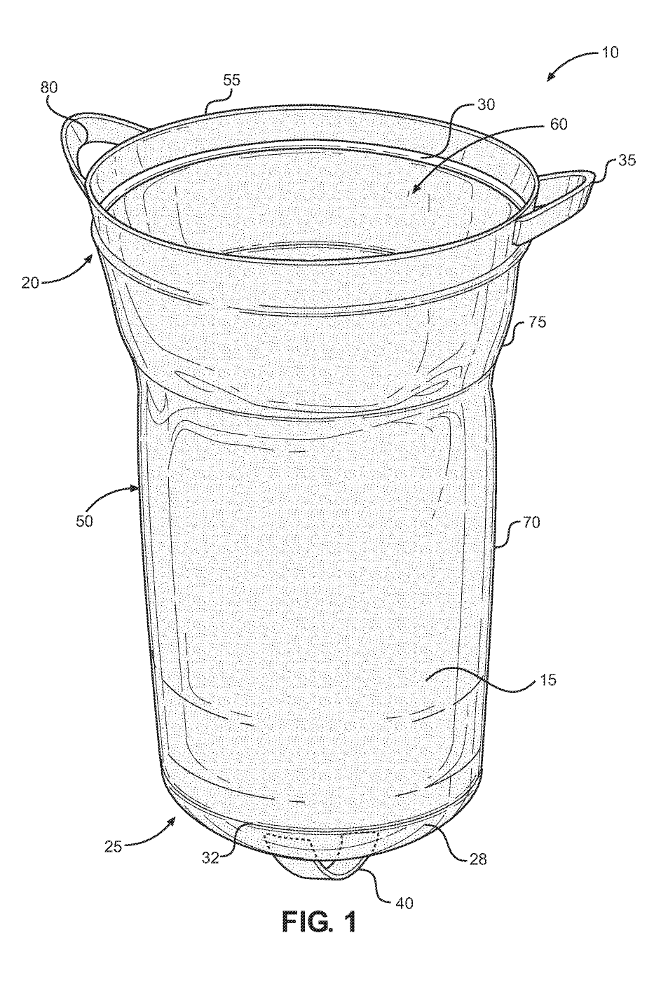

Referring now to FIG. 1, there is shown a perspective view of the trash bin liner. The present invention provides a trash bin liner 10 configured to contain any unsanitary material leaked or spilled as a result of a torn or defective trash bag. The trash bin liner 10 comprises a body 15 having an upper end 20 and a lower end 25, an elastic band 30 disposed on the upper end 20, a pair of handles 35 disposed on the upper end 20, and one or more support handles 40 disposed on the lower end 25 for facilitating the dumping of a trash bag within the liner 10.

The body 15 includes an upstanding sidewall 50 extending vertically upwards from the lower end 25 to the upper end 20. The sidewall 50 defines an interior volume in between the upper end 20 and the lower end 25, which is configured to receive a trash bag therein. The upper end 20 includes a perimeter edge 55 defining an opening 60 for providing access to the interior volume of the body 15. The lower end 25 is closed and defines a base 28 including a perimeter edge 32. In the depicted embodiment, the body 15 includes a cylindrical shape, wherein the sidewall 50 extends annularly around an edge of the lower end 25, thereby forming a tubular interior volume and a circular upper end 20. In alternative embodiments, the body 15 may include any variety of shapes, such as a rectangular, or ovular shape. The body 15 is composed of a flexible unitary piece of material comprising elastic properties, such that it can form fit a trash bin. The elasticity of the material enables the body 15 to expand. The unitary piece of material is washable, such that a user may wash the trash bin liner when dirtied.

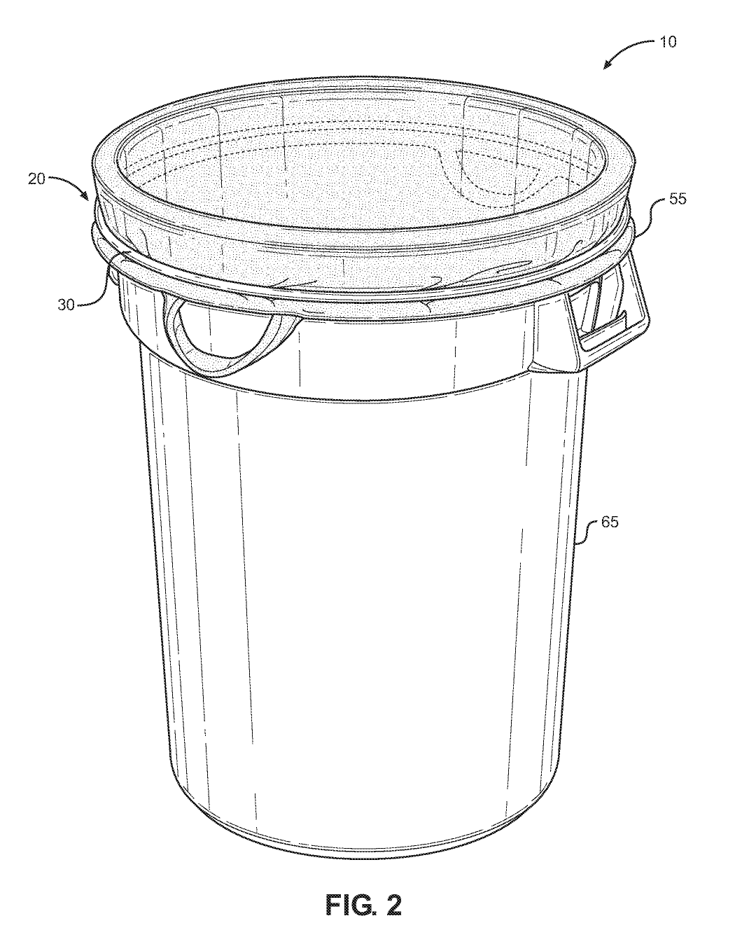

The elastic band 30 is disposed annularly around the upper end 20 of the body 15. The elastic band 30 enables the upper end 20 to expand radially outwardly relative to the interior volume of the body 15. In this way, once the trash bin liner 10 is inserted into a trash bin 65, the upper end 20 can extend radially outwardly over the perimeter edge of the open end of the trash bin 65 and fold thereover, as shown in FIG. 2. The elastic band 30 is biased radially inwardly such the elastic band 30 can exert force back onto the trash bin 65 once folded thereover, thereby securing the trash bin liner 10 to the trash bin 65, as shown in FIG. 2. The elastic band 30 includes an elasticized cord composed of an elastic or stretchable material, such as woven cotton or polypropylene sheath.

In one embodiment, the sidewall 50 includes a vertical section 70 and a tapered section 75 for facilitating the extension of the upper end 20 around the perimeter edge of an opening of a trash can. The tapered section 75 extends radially outwardly relative to the interior volume of the body 15 while the vertical section 70 maintains its radial arrangement. The tapered section 75 begins at the upper end 20 and tapers radially inwardly from the upper end 20 towards the lower end 25, such that the diameter of the tapered section 75 gradually decreases from the upper end 20 towards the lower end 25. The tapered section 75 terminates at the vertical section 70, which extends vertically downward from the tapered section 75 towards the lower end 25. The vertical section 70 terminates at the perimeter edge 32 of the base 28. The tapered section 75 includes a diameter larger than the diameter of the vertical portion 70. In this way, the tapered section 75 facilitates the folding of the upper end 20 over the open end of a trash bin.

The pair of handles 35 are disposed on opposing sides of the upper end 20 and positioned adjacent to the perimeter edge 55 thereof. The pair of handles 35 provide a means by which a user may lift and remove the trash bin liner 10 from a trash bin. In the depicted embodiment, the pair of handles 35 extend radially outwardly relative to the interior volume of the body 15 and forms an arch 80 that extends above the perimeter edge 55 of the upper end 20. In this way, the pair of handles 35 form an open region in between the body 15 and the arch 80 enabling a user to comfortably grab the pair of handles 35 and move or lift the trash bin liner 10. In one embodiment, the pair of handles 35 are composed of a flexible material and are stitched onto the sidewall 50. However, in other embodiments, the pair of handles 35 are integral to the sidewall 50.

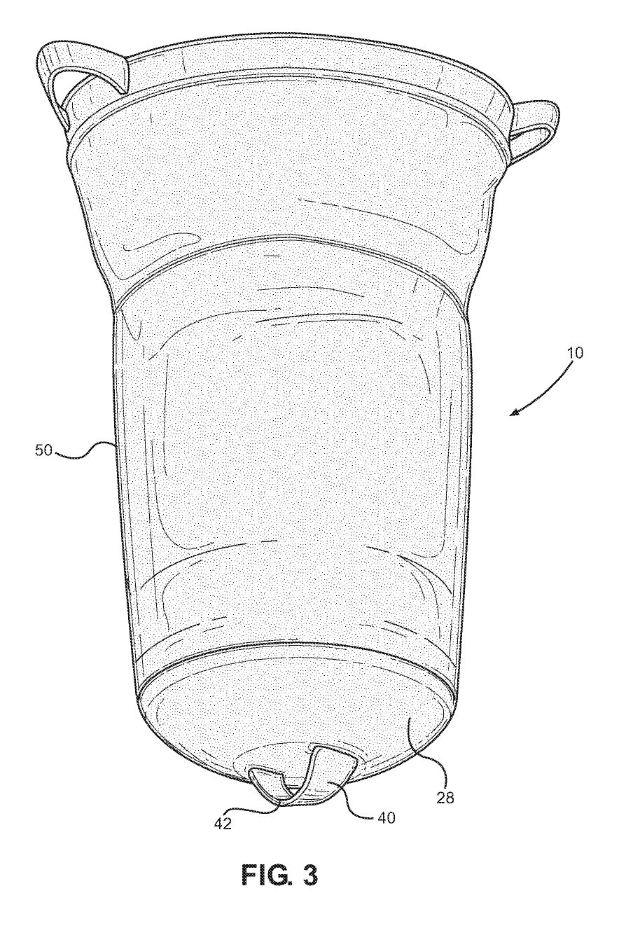

Referring now to FIG. 3, there is shown a perspective bottom view of the trash bin liner. The one or more support handles 40 are disposed on an exterior of the base 28. The one or more support handles 40 enable a user to upend the trash bin liner 10 and remove or shake out its contents. In the depicted embodiment, the trash bin liner 10 includes a single support handle 40 disposed on a center portion of the base 20. The support handle 40 extends vertically, downward relative to the base 28, forming an arch 42. The support handle 40 forms an open region in between the base 28 and the arch 42, enabling a user to comfortably grab the support handle 40 and upend the trash bin liner 10. In one embodiment, the support handle 40 is composed of a flexible material and is stitched onto the sidewall 50. However, in other embodiments, the support handle 35 is integral to the sidewall 50.

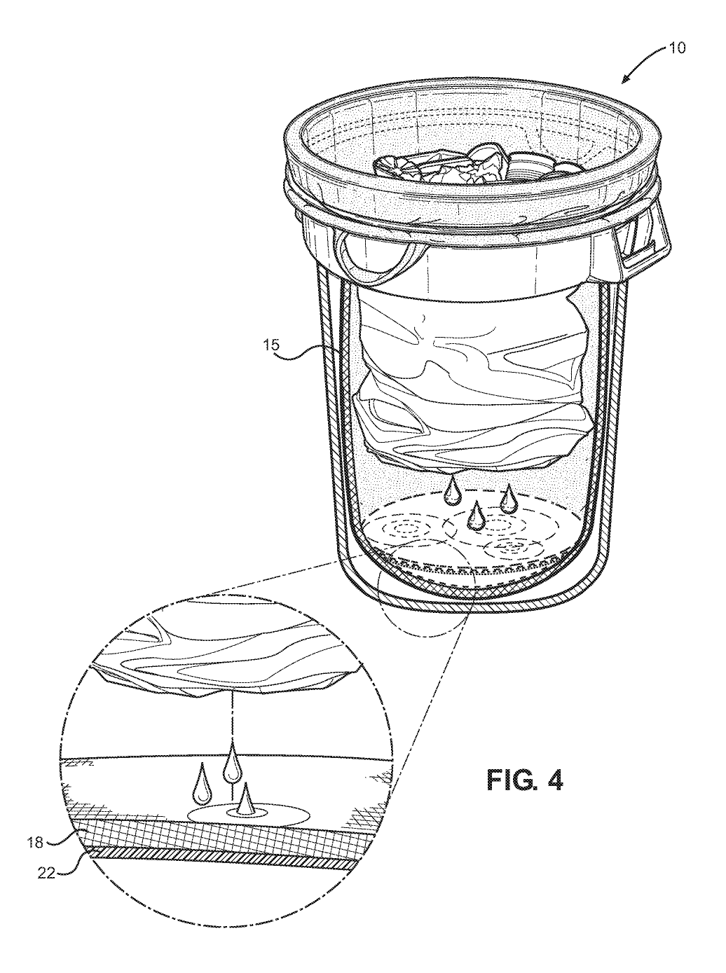

Referring now to FIG. 4, there is shown a cross-sectional view of the trash bin liner. In one embodiment, the body 15 includes an absorbent layer 18 on an interior thereof and a liquid-impermeable layer 22 on an exterior thereof. The absorbent layer 18 absorbs any fluids leaked from a trash bag inserted therein, while the liquid-impermeable layer 22 prevents the fluids absorbed by the absorbent later 18 from seeping out of the trash bin liner 10 and contaminating the interior of a trash bin.

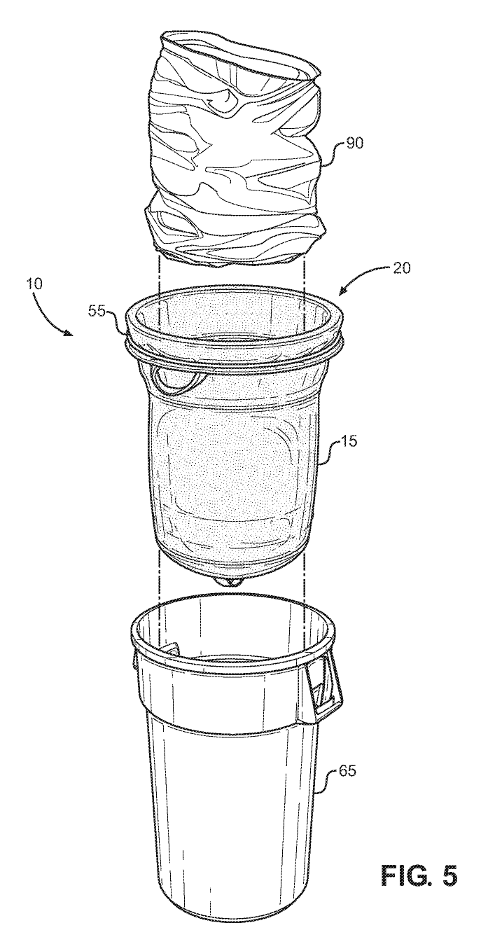

Referring now to FIG. 5, there is shown an exploded view of the trash bin liner being inserted into a trash bin and receiving a trash bag. In one use of the present invention, the body 15 of the trash bin liner 10 is inserted into the interior volume of a trash bin 65. Once inserted, the upper end 20 is folded over the open end of the trash bin 65, such that the elastic band 55 exerts a force against the sidewall of the trash bin 65. Once the trash bin liner 10 is inserted, a trash bag 90 may be inserted into the trash bin liner 10. Effectively, the trash bin liner 10 forms an impermeable layer in between the trash bin 65 and the trash bag 90.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A trash bin liner, comprising:
a body sized to form fit to a trash bin, the body including an upper end, a closed lower end, and an upstanding sidewall extending from the upper end to the closed lower end and defining an interior volume configured to receive a trash bag;
the upstanding sidewall including a tapered section and a vertical section, the tapered section beginning at the upper end and terminating at the vertical section, the vertical section beginning at a lower end of the tapered section and terminating at the closed lower end;
wherein the tapered section extends radially outwardly relative to the interior volume of the body and tapers radially inwardly from the upper end towards the closed lower end;
the tapered section including a diameter larger than a diameter of the vertical section;
the upper end including a perimeter edge defining an opening;
the closed lower end defining a base; and
an elastic band disposed annularly around the upper end, the elastic band biased radially inwardly relative to the interior volume.

2) The trash bin of claim 1, wherein the body is composed of a flexible, washable unitary piece of material including elasticity.

3) The trash bin liner of claim 1, wherein the elastic band comprises an elasticized cord.

4) The trash bin liner of claim 1, further comprising one or more handles disposed on opposing sides of the upper end and adjacent to the perimeter edge thereof.

5) The trash bin liner of claim 4, wherein the one or more handles extend radially outwardly relative to the interior volume of the body and extend above the opening of the upper end.

6) The trash bin liner of claim 4, wherein the one or more handles are composed of the same material as the body.

7) The trash bin liner of claim 1, further comprising a support handle disposed on the base of the lower end.

8) The trash bin liner of claim 7, wherein the support handle is disposed on a center portion of the base.

9) The trash bin liner of claim 7, wherein the support handle is composed of the same material as the body.

10) The trash bin liner of claim 1, further comprising:
an absorbent layer disposed on an interior of the body, the absorbent layer configured to absorb liquid leaked from a trash bag; and
a liquid-impermeable layer disposed on an exterior of the body, the liquid-impermeable layer configured to retain the leaked liquid within the body.
